(19) United States
(12) Patent Application Publication
(10) Pub. No.: US 2014/0226276 A1
(43) Pub. Date: Aug. 14, 2014

(54) NOTEBOOK-TYPE COMPUTER WITH OPEN AND ANGLE ADJUSTMENT FUNCTION, AND MOUSE APPARATUS FOR THE SAME

(71) Applicant: YOUNG HO SUNG, BUCHEON-SI (KR)

(72) Inventor: YOUNG HO SUNG, BUCHEON-SI (KR)

(21) Appl. No.: 14/176,958

(22) Filed: Feb. 10, 2014

(30) Foreign Application Priority Data
Feb. 13, 2013 (KR) 10-2013-0015339

(51) Int. Cl. G06F 1/16

(52) U.S. Cl. CPC G06F 1/1681
USPC 361/679.27

(57) ABSTRACT

The present invention relates to a notebook computer provided with a function of opening and closing a monitor and adjusting an angle of the monitor, and a mouse apparatus therefor. In a notebook computer including a monitor, a main body and a rotation power providing hinge unit for adjusting an angle of the monitor with respect to the main body, the notebook computer includes: an automatic open and close button formed on a rear side of an area implementing a screen of the monitor; and a monitor open and close control module formed on system memory of the main body, transmitting the angle control command to the rotation power providing hinge unit so that a standard angle or a log angle may be formed between the monitor and the main body.

### CROSS REFERENCE RELATED APPLICATION

This application claims foreign priority of Korean Patent Application No. 10-2013-0015339, filed on Feb. 13, 2013, which is incorporated by reference in its entirety into this application.

### BACKGROUND OF THE INVENTION

1. Field of the Invention

The present invention relates to a notebook computer provided with a function of opening and closing a monitor and adjusting an angle of the monitor, and a mouse apparatus therefor, and more specifically, to a notebook computer provided with a function of opening and closing a monitor and adjusting an angle of the monitor, and a mouse apparatus therefor, in which in the notebook type computer including the monitor for implementing a screen and a main body for executing computing functions formed in one piece, an angle between the monitor and the main body is automatically restored to a finally used angle or a standard angle to be adaptive to a user, and a dedicated, not a manual, scroll apparatus is used to finely adjust the restored angle, thereby providing the user with convenience.

2. Background of the Related Art

Generally, a notebook type computer has a monitor for implementing a screen and a main body for executing computing functions formed in one piece, and a user may open the monitor connected to the main body through a hinge unit and simultaneously perform input and output utilizing a keyboard input device and a mouse pointer input pad embedded in the main body or an external mouse apparatus.

However, it is not easy for a user to adjust an angle between the main body and the monitor to be always the same, and several times of manual correction works are required.

In addition, although the angle is adjusted to be the same as a previously used angle, there is a case in which the angle needs to be finely adjusted according to an external environment such as indoor or outdoor illuminance or the like, and even in this case, several times of manual correction works are required as described above.

Accordingly, required in the art is development of a technique for further conveniently and automatically adjusting the angle between the main body and the monitor for the convenience of a user.

### SUMMARY OF THE INVENTION

Therefore, the present invention has been made in view of the above problems, and it is an object of the present invention to provide a notebook computer provided with a function of opening and closing a monitor and adjusting an angle of the monitor, and a mouse apparatus therefor, in which in the notebook type computer including the monitor for implementing a screen and a main body for executing computing functions formed in one piece, an angle between the monitor and the main body is automatically restored to a finally used angle or a standard angle to be adaptive to a user.

In addition, another object of the present invention is to provide a notebook computer provided with a function of opening and closing a monitor and adjusting an angle of the monitor, and a mouse apparatus therefor, in which a dedicated, not a manual, scroll apparatus is used to finely adjust the restored initial angle between the main body and the monitor, thereby providing the user with convenience.

In addition, still another object of the present invention is to provide a notebook computer provided with a function of opening and closing a monitor and adjusting an angle of the monitor, and a mouse apparatus therefor, in which since the angle between the main body and the monitor is adjusted by performing a scroll through a mouse wheel using a dedicated mouse apparatus, a monitor angle adjustment scroll input terminal, which is a dedicated scroll apparatus formed in the notebook computer, may be replaced.

However, objects of the present invention are not limited to the above-mentioned objects, and unmentioned other objects may be clearly understood by those skilled in the art from the following descriptions.

To accomplish the above objects, according to a first embodiment of the present invention, there is provided a notebook computer provided with a function of opening and closing a monitor and adjusting an angle of the monitor, and in the notebook computer including a monitor, a main body and a rotation power providing hinge unit for adjusting an angle of the monitor with respect to the main body, the notebook computer includes: an automatic open and close button formed on a rear side of an area implementing a screen of the monitor; and a monitor open and close control module formed on system memory of the main body, for reading, if an automatic open and close request signal is received from the automatic open and close button while the monitor is folded on the main body, standard angle informational stored in a log storage unit of the main body or log angle information a2 corresponding to information on an angle between the monitor and the main body in a state finally used by a user, creating an angle control command of a state corresponding to the read standard angle informational or log angle information a2, and transmitting the angle control command to the rotation power providing hinge unit so that a standard angle or a log angle may be formed between the monitor and the main body.

At this point, the main body preferably includes: a monitor angle adjustment scroll input terminal formed on a left or right side of a mouse pointer input pad; and a monitor tilting control module for receiving, when control of the angle between the monitor and the main body according to the standard angle informational or the log angle information a2 read by the monitor open and close control module is completed to be executed by the rotation power providing hinge unit, an initial angle adjustment completion signal from the monitor open and close control module and performing automatic angle adjustment according to an upward or downward scroll input inputted into the monitor angle adjustment scroll input terminal.

In addition, when the initial angle adjustment completion signal is received, the monitor tilting control module preferably waits for reception of an angle adjustment scroll control signal (tilting-command sig) containing upward or downward scroll moving distance information from the monitor angle adjustment scroll input terminal.

In addition, when the angle adjustment scroll control signal (tilting-command sig) is received, the monitor tilting control module preferably extracts the upward or downward scroll moving distance information, calculates an angle for upward or downward tilting to move the monitor from a current angle, and transmits an angle control command containing information on the calculated angle to the rotation power providing hinge unit to automatically control the angle.

In addition, the main body preferably includes: an I/O interface which is an input and output terminal for transmitting and receiving signals and data to and from a dedicated mouse apparatus in a wired or wireless method; and a remote mouse control module for maintaining, if the initial angle adjustment completion signal is received from the monitor open and close control module, a reception standby state through the I/O interface in response to a remote adjustment request received from the dedicated mouse apparatus in a wired or wireless method and controlling the rotation power providing hinge unit to adjust the angle of the monitor with respect to the main body according to angle adjustment information contained in the received remote adjustment request.

In addition, the notebook computer according to the present invention preferably further includes an automatic and manual mode switch button for performing an automatic open and close mode through an automatic control on the rotation power providing hinge unit by the monitor open and close control module and the monitor tilting control module or a manual open and close mode performed by a user.

To accomplish the above objects, according to a second embodiment of the present invention, there is provided a notebook computer provided with a function of opening and closing a monitor and adjusting an angle of the monitor, the notebook computer including: an automatic open and close button formed on a rear side of an area implementing a screen of the monitor; a monitor angle adjustment scroll input terminal formed on a left or right side of a mouse pointer input pad of the main body; an I/O interface which is an input and output terminal for transmitting and receiving signals and data to and from a dedicated mouse apparatus in a wired or wireless method; a monitor open and close control module for reading, if an automatic open and close request signal is received from the automatic open and close button while the monitor is folded on the main body, standard angle informational stored in a log storage unit of the main body or log angle information a2 corresponding to information on an angle between the monitor and the main body in a state finally used by a user, creating an angle control command of a state corresponding to the read standard angle informational or log angle information a2, and transmitting the angle control command to the rotation power providing hinge unit so that a standard angle or a log angle may be formed between the monitor and the main body; a monitor tilting control module for receiving, when control of the angle between the monitor and the main body according to the standard angle informational or the log angle information a2 read by the monitor open and close control module is completed to be executed by the rotation power providing hinge unit, an initial angle adjustment completion signal from the monitor open and close control module and performing automatic angle adjustment according to an upward or downward scroll input inputted into the monitor angle adjustment scroll input terminal; and a remote mouse control module for maintaining, if the initial angle adjustment completion signal is received from the monitor open and close control module, a reception standby state through the I/O interface in response to a remote adjustment request received from the dedicated mouse apparatus in a wired or wireless method and controlling the rotation power providing hinge unit to adjust the angle of the monitor with respect to the main body according to angle adjustment information contained in the received remote adjustment request.

To accomplish the above objects, in a mouse apparatus including a mouse wheel, a mouse button unit divided into a right input button and a left input button, and a micro control unit, the mouse apparatus for a notebook computer provided with a function of opening and closing a monitor and adjusting an angle of the monitor includes: a remote adjustment button formed at a front part of a left or right side surface of a body, for transmitting a remote adjustment request to the notebook computer to remotely adjust an angle between a main body and the monitor of the notebook computer provided with a function of opening and closing a monitor and adjusting an angle of the monitor by the micro control unit when an input operation is performed.

In addition, before transmitting the remote adjustment request, the micro control unit preferably creates and transmits the remote adjustment request to the notebook computer when an input operation is performed using the remote adjustment button after an initial angle adjustment completion signal for completing initial angle adjustment at an angle corresponding to standard angle informational stored in a log storage unit of the notebook computer or log angle information a2 corresponding to information on an angle between the monitor and the main body in a state finally used by a user is received from the notebook computer.

In addition, if the user inputs an upward or downward scroll using the mouse wheel, the micro control unit preferably creates and transmits upward angle adjustment information or downward angle adjustment information proportional to an upward or downward scroll moving distance to the notebook computer.

### BRIEF DESCRIPTION OF THE DRAWINGS

FIG. 1 is a perspective view showing a state before automatic open and close of a notebook computer 100 provided with a function of opening and closing a monitor and adjusting an angle of the monitor according to an embodiment of the present invention.

FIG. 2 is a perspective view showing a state after automatic open and close of the notebook computer 100 of FIG. 1 provided with a function of opening and closing a monitor and adjusting an angle of the monitor.

FIG. 3 is view showing a mouse apparatus 200 (hereinafter, referred to as a dedicated mouse apparatus) for a notebook computer provided with a function of opening and closing a monitor and adjusting an angle of the monitor, which is provided for the notebook computer 100 of FIG. 1 provided with a function of opening and closing a monitor and adjusting an angle of the monitor before automatic open and close.

FIG. 4 is view showing a dedicated mouse apparatus 200 provided for the notebook computer 100 of FIG. 2 provided with a function of opening and closing a monitor and adjusting an angle of the monitor after automatic open and close.

FIG. 5 is a block diagram showing the entire configuration of a notebook computer 100 provided with a function of opening and closing a monitor and adjusting an angle of the monitor according to an embodiment of the present invention.

FIG. 6 is a block diagram showing the entire configuration of a dedicated mouse apparatus 200 according to an embodiment of the present invention.

### DESCRIPTION OF SYMBOLS

100: Notebook computer provided with a function of opening and closing a monitor and adjusting an angle of the monitor
110: Monitor
111: Automatic open and close button
120: Main body
121: Mouse pointer input pad
122: Keyboard input device
123: Monitor angle adjustment scroll input terminal
124: Central control device
125: System memory
125a: Monitor open and close control module
125b: Monitor tilting control module
125c: Remote mouse control module
126: Storage device
126a: Log storage unit
130: Rotation power providing hinge unit
140: I/O interface
200: Dedicated mouse apparatus
210: Remote adjustment button
220: Mouse wheel
230: Mouse button unit
230a: Right input button
230b: Left input button
240: Transmission and reception unit
250: Micro control unit

### DETAILED DESCRIPTION OF THE PREFERRED EMBODIMENT

The preferred embodiments of the invention will be hereafter described in detail with reference to the accompanying drawings. In addition, in describing the operating principles of the preferred embodiments of the present invention in detail, if already known functions or specific description of constitution related to the present invention may make the spirit of the present invention unclear, detailed description thereof will be omitted.

In the specification, when any one of constitutional components ‘transmits’ a data or a signal to another constitutional component, the constitutional component may directly transmits the data or the signal to another constitutional component or may transmit the data or the signal to another constitutional component through at least one of the other constitutional components.

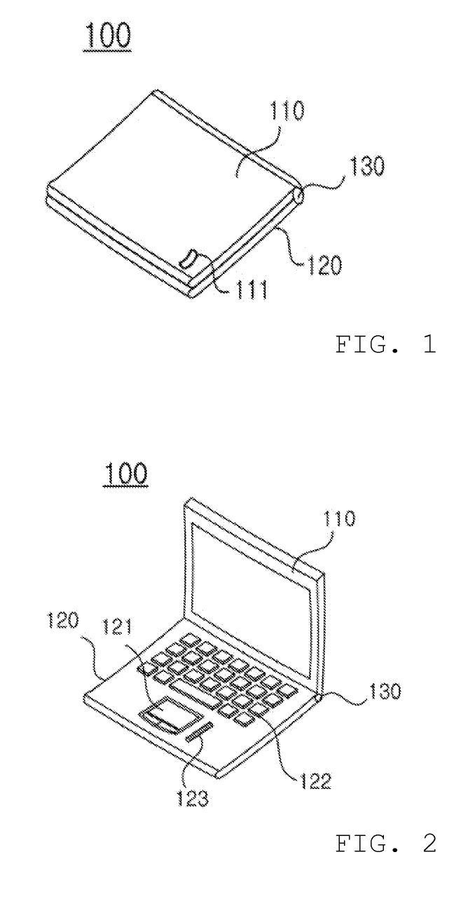

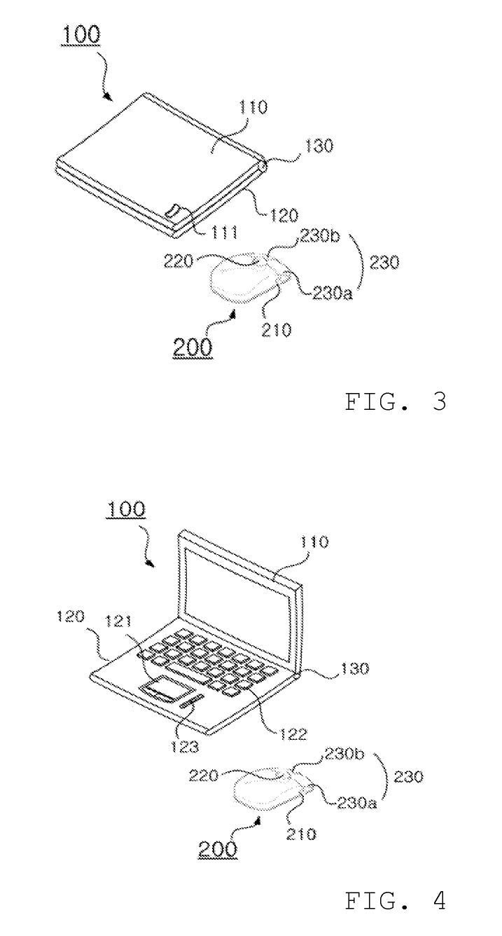

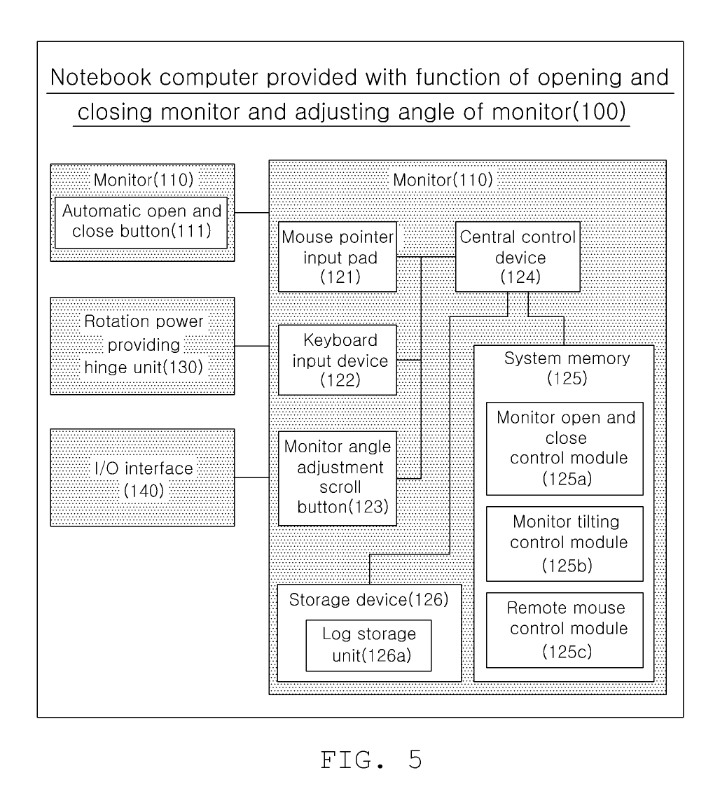

FIG. 1 is a perspective view showing a state before automatic open and close of a notebook computer 100 provided with a function of opening and closing a monitor and adjusting an angle of the monitor according to an embodiment of the present invention. FIG. 2 is a perspective view showing a state after automatic open and close of the notebook computer 100 of FIG. 1 provided with a function of opening and closing a monitor and adjusting an angle of the monitor. FIG. 3 is view showing a mouse apparatus 200 (hereinafter, referred to as a dedicated mouse apparatus) for a notebook computer provided with a function of opening and closing a monitor and adjusting an angle of the monitor, which is provided for the notebook computer 100 of FIG. 1 provided with a function of opening and closing a monitor and adjusting an angle of the monitor before automatic open and close. FIG. 4 is view showing a dedicated mouse apparatus 200 provided for the notebook computer 100 of FIG. 2 provided with a function of opening and closing a monitor and adjusting an angle of the monitor after automatic open and close.

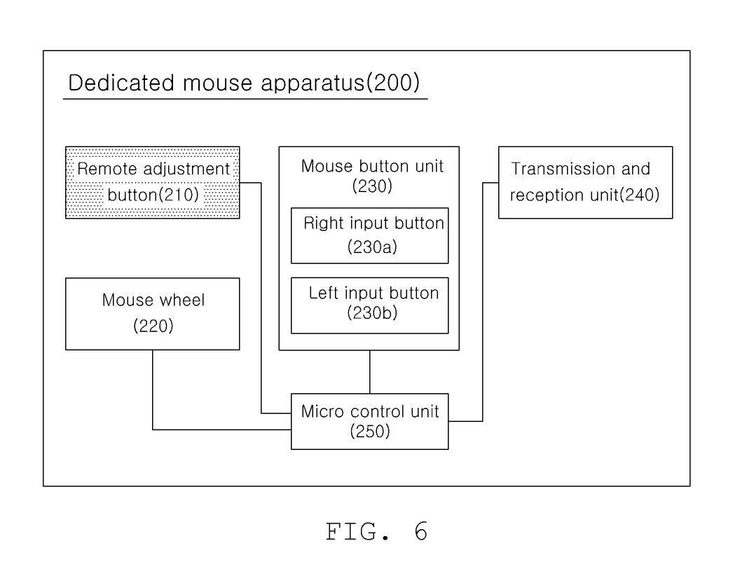

FIG. 5 is a block diagram showing the entire configuration of a notebook computer 100 provided with a function of opening and closing a monitor and adjusting an angle of the monitor according to an embodiment of the present invention. FIG. 6 is a block diagram showing the entire configuration of a dedicated mouse apparatus 200 according to an embodiment of the present invention.

Hereinafter, a notebook computer 100 provided with a function of opening and closing a monitor and adjusting an angle of the monitor and a dedicated mouse apparatus 200 will be described in detail with reference to FIGS. 1 to 6.

First, the notebook computer 100 provided with a function of opening and closing a monitor and adjusting an angle of the monitor includes the monitor 110, a main body 120, a rotation power providing hinge unit 130 and an I/O interface (input and output interface) 140.

The monitor 110 includes an automatic open and close button 111. The automatic open and close button 111 is formed on a rear side of an area implementing a screen of the monitor 110 for the convenience of automatic or manual opening and closing of the monitor 110 from the main body 120 centering on the rotation power providing hinge unit 130, and although the automatic open and close button 111 is formed at a lower right side of the folded monitor 110 in FIGS. 1 and 3, it is not limited thereto.

The automatic open and close button 111 creates an automatic open and close request signal according to input of a user and transmits the automatic open and close request signal to a monitor open and close control module 125a loaded on system memory 125 through a central control device 124 of the main body 120.

The main body 120 includes a mouse pointer input pad 121, a keyboard input device 122, a monitor angle adjustment scroll input terminal 123, the central control device 124, the system memory 125 and a storage device 126, and the storage device 126 includes a log storage unit 126a. Meanwhile, a monitor open and close control module 125a, a monitor tilting control module 125b and a remote mouse control module 125c are loaded on the system memory 125 individually or as a package by the central control device 124.

In the present invention, the system memory 125 is non-volatile memory (NVM), in which data stored therein are continued to be maintained and not deleted although power is not supplied, and may be configured of flash memory, magnetic random access memory (MRAM), phase-change random access memory (PRAM), ferroelectric RAM (FRAM) or the like.

Hereinafter, the modules 125a, 125b and 125c formed in the system memory 125 will be described in detail focusing on the relations with other constitutional components of the main body 120.

In addition, a module in this specification may mean a functional and structural combination of hardware for executing technical spirits of the present invention and software for driving the hardware. For example, a corresponding module may mean a certain code and a logical unit of a hardware resource for executing the certain code, and those skilled in the art may easily infer that it does not necessarily mean a physically connected code or one kind of hardware.

First, if the automatic open and close request signal is received from the automatic open and close button 111, the monitor open and close control module 125a reads standard angle informational stored in the log storage unit 126a of the storage unit 126 or log angle information a2 corresponding to information on an angle between the monitor 110 and the main body 120 in a state finally used by the user and transmits an angle control command to the rotation power providing hinge unit 130 so that an angle may be formed between the monitor 110 and the main body 120 in a state corresponding to the read standard angle information a1 or log angle information a2.

Accordingly, the rotation power providing hinge unit 130 is driven to move the monitor 110 by rotation with respect to the main body 120 as much as the angle information a1 or a2 contained in the angle control command. Here, an embodiment of the movement by rotation may be implemented using a step motor provided inside the rotation power providing hinge unit 130.

When control of the angle between the monitor 110 and the main body 120 according to the standard angle informational or the log angle information a2 read by the monitor open and close control module 125a is completed to be executed by the rotation power providing hinge unit 130, the monitor tilting control module 125b receives an initial angle adjustment completion signal from the monitor open and close control module 125a.

Then, the monitor tilting control module 125b waits for reception of an angle adjustment scroll control signal (tilting-command sig) containing information on an upward or downward scroll moving distance from the monitor angle adjustment scroll input terminal 123 formed on the left or right side of the mouse pointer input pad 121.

When the angle adjustment scroll control signal (tilting-command sig) is received, the monitor tilting control module 125b extracts the upward or downward scroll moving distance information, calculates an angle for upward or downward tilting to move the monitor 110 from the current angle, and controls the rotation power providing hinge unit 130 to adjust the angle according to the angle control command containing the calculated angle information.

The I/O interface 140 corresponds to an input and output terminal for transmitting and receiving signals and data to and from peripheral devices. That is, the I/O interface 140 in the present invention may recognize the dedicated mouse apparatus 200, which is one of the peripheral devices, in a plug and play method provided by the central control device 124 of the main body 120.

Meanwhile, as an embodiment of the present invention, the I/O interface 140 is formed to insert a USB cable of the dedicated mouse apparatus 200 when the dedicated mouse apparatus 200 transmits and receives signals and data to and from the central control device 124 of the main body 120 in a wired method, and the I/O interface 140 is formed to insert a Dongle of the dedicated mouse apparatus 200 when the dedicated mouse apparatus 200 transmits and receives signals and data to and from the central control device 124 of the main body 120 in a wireless method (e.g., BlueTooth, WLAN or the like).

Before describing the remote mouse control module 125c, the configuration of the dedicated mouse apparatus 200 will be described. The dedicated mouse apparatus 200 includes a remote adjustment button 210, a mouse wheel 220, a mouse button unit 230, a transmission and reception unit 240 and a micro control unit 250. In addition, the mouse button unit 230 includes a right input button 230a and a left input button 230b, and since these are the same as the buttons formed in a general wireless or wired mouse, details thereof will be omitted.

The dedicated mouse apparatus 200 of the present invention may be formed as both a wired-type dedicated mouse apparatus for transmitting and receiving signals and data in a wired method and a wireless-type dedicated mouse apparatus for transmitting and receiving signals and data in a wireless method.

The transmission and reception unit 240 of the dedicated mouse apparatus 200 is formed as a USB cable or a wireless Dongle in hardware and controlled by the micro control unit 250 to mutually recognize or make a pair together with the I/O interface 140 of the main body 120 on the notebook computer 100 according to the present invention.

Meanwhile, the remote adjustment button 210 described above is formed on the left or right side surface of the body of the dedicated mouse apparatus 200 and is formed at a front part of the left or right side surface for the input convenience of the user so as not to hinder a grip operation of the user on the dedicated mouse apparatus 200, and, generally, it is preferable to form the remote adjustment button 210 at a front part of the right side surface so that a grip operation of a thumb may not be hindered from the standpoint of a right-handed person.

The remote mouse control module 125c will be described focusing on the configuration of such a dedicated mouse apparatus 200.

The remote adjustment button 210 creates a remote adjustment signal according to input of a user and transmits the remote adjustment signal to the micro control unit 250. Accordingly, the micro control unit 250 controls the transmission and reception unit 240 to transmit a remote adjustment request to the remote mouse control module 125c through the central control device 124 on the notebook computer 100 provided with a function of opening and closing a monitor and adjusting an angle of the monitor.

Meanwhile, if an initial angle adjustment completion signal is received from the monitor open and close control module 125a, the remote mouse control module 125c maintains a reception standby state through the I/O interface 140 in response to the remote adjustment request received from the dedicated mouse apparatus 200 in a wired or wireless method and then controls the I/O interface 140 to transmit a remote adjustment completion signal to the dedicated mouse apparatus 200.

Accordingly, if a user inputs an upward or downward scroll using the mouse wheel 220, the micro control unit 250 creates upward angle adjustment information or downward angle adjustment information proportional to an upward or downward scroll moving distance and controls the transmission and reception unit 240 to transmit the upward angle adjustment information or the downward angle adjustment information to the remote mouse control module 125c.

The remote mouse control module 125c receives the upward angle adjustment information or the downward angle adjustment information through the I/O interface 140 and controls the rotation power providing hinge unit 130 to adjust the angle according to the upward angle adjustment information or the downward angle adjustment information so that the angle of the monitor 110 may be automatically adjusted according to the scroll of the mouse wheel 220 on the dedicated mouse apparatus 200. Accordingly, even when the monitor angle adjustment scroll input terminal 123 on the main body 120 does not exist or operate, the angle of the monitor 110 can be automatically controlled using an existing mouse wheel 220.

Meanwhile, an automatic and manual mode switch button for performing an automatic open and close mode of the monitor 110 and the main body 120 according to the present invention or an existing manual open and close mode may be formed on the notebook computer 100 provided with a function of opening and closing a monitor and adjusting an angle of the monitor.

Such an automatic and manual mode switch button may stop an automatic rotation mode of the rotation power providing hinge unit 130 by transmitting a manual open and close request to the central control device 124 when the manual open and close mode is requested according to input of a user.

Meanwhile, the dedicated mouse apparatus 200 and the notebook computer 100 provided with a function of opening and closing a monitor and adjusting an angle of the monitor may be further provided with a rotation plate (not shown) on the bottom, respectively.

When the dedicated mouse apparatus 200 rotates left and right centering on the rotation plate, the remote adjustment button 210 creates a remote adjustment signal and transmits the remote adjustment signal to the remote mouse control module 125c.

The remote mouse control module 125c may control to rotate the notebook computer 100 having an angle adjustment function centering on the rotation plate provided on the bottom according to the remote adjustment signal.

In a notebook type computer including a monitor for implementing a screen and a main body for executing computing functions formed in one piece, the notebook computer provided with a function of opening and closing the monitor and adjusting an angle of the monitor and a mouse apparatus therefor according to an embodiment of the present invention provide an effect of automatically restoring an angle between the monitor and the main body to a finally used angle or a standard angle to be adaptive to a user.

A notebook computer provided with a function of opening and closing a monitor and adjusting an angle of the monitor and a mouse apparatus therefor according to another embodiment of the present invention provide a user with convenience by using a dedicated, not a manual, scroll apparatus to finely adjust the restored initial angle between the main body and the monitor.

Furthermore, a notebook computer provided with a function of opening and closing a monitor and adjusting an angle of the monitor and a mouse apparatus therefor according to still another embodiment of the present invention provide an effect of replacing a monitor angle adjustment scroll input terminal, which is a dedicated scroll apparatus formed in the notebook computer, since the angle between the main body and the monitor is adjusted by performing a scroll through a mouse wheel using a dedicated mouse apparatus.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. In a notebook computer including a monitor, a main body and a rotation power providing hinge unit for adjusting an angle of the monitor with respect to the main body, the notebook computer provided with a function of opening and closing the monitor and adjusting the angle of the monitor, the notebook computer comprising:
an automatic open and close button formed on a rear side of an area implementing a screen of the monitor; and
a monitor open and close control module formed on system memory of the main body, for reading, if an automatic open and close request signal is received from the automatic open and close button while the monitor is folded on the main body, standard angle informational stored in a log storage unit of the main body or log angle information a2 corresponding to information on an angle between the monitor and the main body in a state finally used by a user, creating an angle control command of a state corresponding to the read standard angle information a1 or log angle information a2, and transmitting the angle control command to the rotation power providing hinge unit so that a standard angle or a log angle may be formed between the monitor and the main body.

2. The notebook computer according to claim 1, wherein the main body includes:
a monitor angle adjustment scroll input terminal formed on a left or right side of a mouse pointer input pad; and
a monitor tilting control module for receiving, when control of the angle between the monitor and the main body according to the standard angle informational or the log angle information a2 read by the monitor open and close control module is completed to be executed by the rotation power providing hinge unit, an initial angle adjustment completion signal from the monitor open and close control module and performing automatic angle adjustment according to an upward or downward scroll input inputted into the monitor angle adjustment scroll input terminal.

3. The notebook computer according to claim 2, wherein when the initial angle adjustment completion signal is received, the monitor tilting control module waits for reception of an angle adjustment scroll control signal (tilting-command sig) containing upward or downward scroll moving distance information from the monitor angle adjustment scroll input terminal.

4. The notebook computer according to claim 3, wherein when the angle adjustment scroll control signal (tilting-command sig) is received, the monitor tilting control module extracts the upward or downward scroll moving distance information, calculates an angle for upward or downward tilting to move the monitor from a current angle, and transmits an angle control command containing information on the calculated angle to the rotation power providing hinge unit to automatically control the angle.

5. The notebook computer according to claim 4, wherein the main body includes:
an I/O interface which is an input and output terminal for transmitting and receiving signals and data to and from a dedicated mouse apparatus in a wired or wireless method; and
a remote mouse control module for maintaining, if the initial angle adjustment completion signal is received from the monitor open and close control module, a reception standby state through the I/O interface in response to a remote adjustment request received from the dedicated mouse apparatus in a wired or wireless method and controlling the rotation power providing hinge unit to adjust the angle of the monitor with respect to the main body according to angle adjustment information contained in the received remote adjustment request.

6. The notebook computer according to claim 5, further comprising an automatic and manual mode switch button for performing an automatic open and close mode through an automatic control on the rotation power providing hinge unit by the monitor open and close control module and the monitor tilting control module or a manual open and close mode performed by a user.

7. In a mouse apparatus including a mouse wheel, a mouse button unit divided into a right input button and a left input button, and a micro control unit, the mouse apparatus for a notebook computer provided with a function of opening and closing a monitor and adjusting an angle of the monitor, the mouse apparatus comprising:
a remote adjustment button formed at a front part of a left or right side surface of a body, for transmitting a remote adjustment request to the notebook computer to remotely adjust an angle between a main body and the monitor of the notebook computer provided with a function of opening and closing a monitor and adjusting an angle of the monitor by the micro control unit when an input operation is performed.

8. The mouse apparatus according to claim 7, wherein before transmitting the remote adjustment request, the micro control unit creates and transmits the remote adjustment request to the notebook computer when an input operation is performed using the remote adjustment button after an initial angle adjustment completion signal for completing initial angle adjustment at an angle corresponding to standard angle informational stored in a log storage unit of the notebook computer or log angle information a2 corresponding to information on an angle between the monitor and the main body in a state finally used by a user is received from the notebook computer.

9. The mouse apparatus according to claim 8, wherein if the user inputs an upward or downward scroll using the mouse wheel, the micro control unit creates and transmits upward angle adjustment information or downward angle adjustment information proportional to an upward or downward scroll moving distance to the notebook computer.

10. In a notebook computer including a monitor, a main body and a rotation power providing hinge unit for adjusting an angle of the monitor unit with respect to the main body, the notebook computer provided with a function of opening and closing the monitor and adjusting the angle of the monitor, the notebook computer comprising:
an automatic open and close button formed on a rear side of an area implementing a screen of the monitor;
a monitor angle adjustment scroll input terminal formed on a left or right side of a mouse pointer input pad of the main body;
an I/O interface which is an input and output terminal for transmitting and receiving signals and data to and from a dedicated mouse apparatus in a wired or wireless method;
a monitor open and close control module for reading, if an automatic open and close request signal is received from the automatic open and close button while the monitor is folded on the main body, standard angle informational stored in a log storage unit of the main body or log angle information a2 corresponding to information on an angle between the monitor and the main body in a state finally used by a user, creating an angle control command of a state corresponding to the read standard angle informational or log angle information a2, and transmitting the angle control command to the rotation power providing hinge unit so that a standard angle or a log angle may be formed between the monitor and the main body;
a monitor tilting control module for receiving, when control of the angle between the monitor and the main body according to the standard angle informational or the log angle information a2 read by the monitor open and close control module is completed to be executed by the rotation power providing hinge unit, an initial angle adjustment completion signal from the monitor open and close control module and performing automatic angle adjustment according to an upward or downward scroll input inputted into the monitor angle adjustment scroll input terminal; and
a remote mouse control module for maintaining, if the initial angle adjustment completion signal is received from the monitor open and close control module, a reception standby state through the I/O interface in response to a remote adjustment request received from the dedicated mouse apparatus in a wired or wireless method and controlling the rotation power providing hinge unit to adjust the angle of the monitor with respect to the main body according to angle adjustment information contained in the received remote adjustment request.
